(19) United States
(12) Patent Application Publication
(10) Pub. No.: US 2010/0291944 A1
(43) Pub. Date: Nov. 18, 2010

(54) COGNITIVE NETWORK

(76) Inventor: Zion Hadad, Petah Tikva (IL)

Correspondence Address: ROBERT G. LEV, 4766 MICHIGAN BLVD., YOUNGSTOWN, OH, 44505, US

(21) Appl. No.: 12/734,412

(22) PCT Filed: Oct. 31, 2007
(86) PCT No.: PCT/IL07/01327

§ 371 Date: Apr. 29, 2010

(51) Int. Cl. H04W 72/04

(52) U.S. Cl. 455/452.1

(57) ABSTRACT

A cellular network including means for sensing the presence of Microphones and Broadcastings and for adjusting resources usage for not interfering the transmissions of the Microphones and Broadcastings. A cellular network including means for sensing the presence of Microphones and Broadcastings and for adjusting resources usage for not interfering with the transmissions of the Microphones and Broadcastings over a certain level.

### FIELD OF THE INVENTION

This invention relates to cellular networks, and more specifically to implementing a cellular network in the presence of other wireless devices or networks.

### BACKGROUND OF THE INVENTION

It is desirable to implement an OFDMA, Cellular, Wimax and/or other kind of network in the presence of another network, broadcasting systems and possible radio microphones.

This relates to a stationary network, such as in urban areas for residential and commercial uses.

Possible problems in implementing such networks:

Radio Microphones may be used, such as unidirectional microphones or equivalent devices. It is not known where and when such devices would transmit. In case their bands and/or channels and/or time/frequency resources are used by the cellular network, possible interference problems may occur.

Thus, some microphones may not function properly or may operate at reduced quality, because cellular network transmissions of Base Stations BS's or of cellular network users, may add noise to the microphone transmissions.

Broadcasting Network or equivalent—this network may use directional transmission means.

The network may contain broadcasting stations, or other hardware means, which will all be referred as B.C. The cellular network might interfere the B.C. transmissions, such as in cases where the cellular network would transmit to the same direction of the client who receives the broadcast transmission.

There may be many B.C. transmissions, in different frequencies and directions, which may further limit the cellular network.

At the same time, it is desired to use as much bandwidth as possible, for giving the users more resources. Some cellular networks and/or standards may support adaptive resources allocations, however they would have to be adjusted to B.C.s and microphones.

### SUMMARY OF THE INVENTION

The new invention may allow deploying several networks at the same time in a certain area, without interfering too much.

This network can be implemented, for example, in the presence of:

1. Unidirectional microphone or equivalent device. It is not known where and when such a device would transmit. However it is possible to check at the user's side and at the BS's side for such transmissions. This may be implemented, for example, by opening windows.

2. Broadcasting Network or equivalent—this network may use directional transmission means. Preferably these transmissions are continuous and may be identified.

The network may contain broadcasting stations, or other hardware means, which will all be referred as B.C. The B.C. transmissions may contain CW, allowing an easier identification.

It is possible to find and/or define where B.C.'s are placed, to which directions they transmit and in what frequencies.

The invention may refer to cognitive radio, that is a network which performs scanning for adjusting itself to other transmissions.

Sensing may be done on fixed time intervals. Such a cellular network is capable of self-configuration, such as according to standard 802.16 and/or using OFDMA-compatible system.

The invention may be implemented with WRAN Wireless Regional Area Network and/or standard 802.22.

The invention may allow using unlicensed bands as well as licensed ones, wherein the unlicensed bands are monitored, sensed and/or being scanned for other transmissions, known or unknown.

It is preferred that other services, service providers or primal services will not be affected from the presence of a cellular and/or OFDMA network, despite its use of some of their frequency bands.

It is preferred that both cellular users; user terminals UT's and Base Stations BS's, would have some free spare resources, such as unused bandwidth at the cellular network licensed bands, so that it would be possible to release unlicensed bands from use easily and quickly, and direct them to the safe spare bands without disrupting the communication in the cellular network.

Further objects, advantages and other features of the present invention will become obvious to those skilled in the art upon reading the disclosure set forth hereinafter.

### BRIEF DESCRIPTION OF THE DRAWINGS

FIG. 1 illustrates a second adaptive wireless system overlaid on an existing, first wireless broadcasting network

FIG. 2 details a transmit frame for OFDMA including Sensing windows set in the time/frequency domain

FIG. 3 details the main lobe and side lobes of a user's terminal antenna for directional transmission towards a base station of the new system and for prevention or reduction of interferences.

FIG. 4 illustrates a system with router means for communicating between a residential community and a base station of the second system, wherein the second system base station is generally in the same direction as the first system base station.

FIG. 5 illustrates a macro-diversity system with several repeaters to be used with a cellular network in a residential community.

### DETAILED DESCRIPTION OF THE PREFERRED EMBODIMENTS

The following invention shall now be described by way of example, and with reference to the accompanying drawings.

Definitions:

B.S. or BS refers to a Base Station of the Cellular network. UT or U.T. refers to a User Terminal or user of the cellular network. B.C. or BC refers to a Broadcasting station or resource. Microphone refers to radio microphone or other equivalent device or system.

This invention may be implemented using 802.22 WRAN standard.

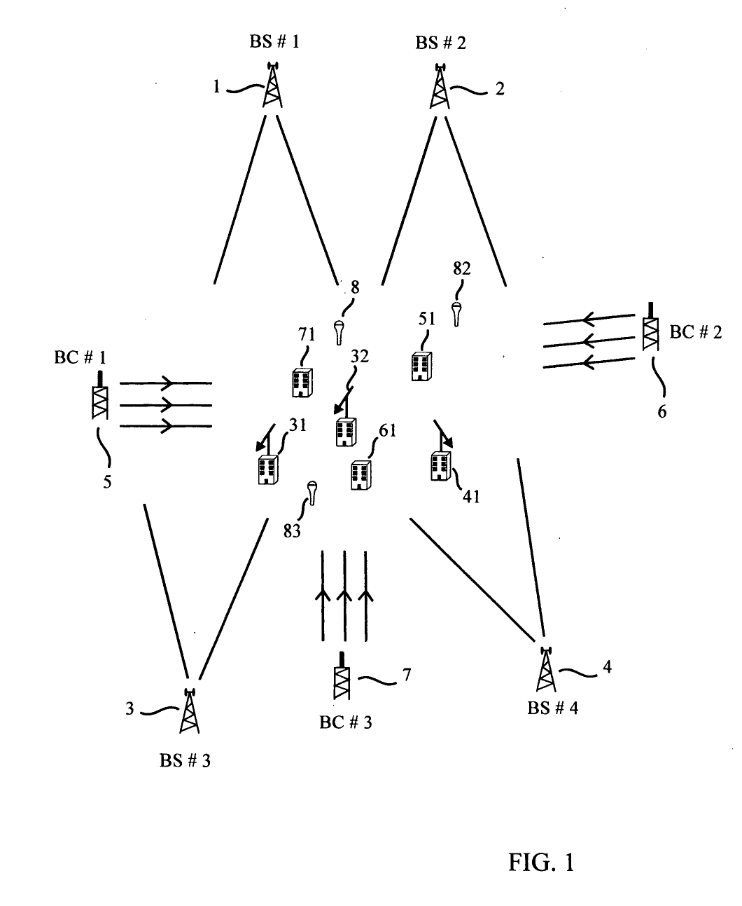

FIG. 1 illustrates a second adaptive wireless system comprising BS's 1-4 overlaid on an existing, first wireless broadcasting network, comprising BC stations 5-7.

In preferred embodiments, the wireless network is based on OFDMA and/or Wimax technology, such as described in standard 802.16.

It may be possible to define resources for use over frequency, such as channels, as well as resources for use in time, such as frames, or a combination thereof. Thus, a UT may be granted specific resources. This may allow updating the allowed resources for use in real time by one or more BS's, which communicate with the UT.

UT's may use directional communication means, such as directional antennas and/or more than one antenna, for achieving this purpose.

BS's may use directional communication means in a similar way. In addition, sectors and/or limited areas can be defined, for managing the communication resources.

It may be possible to set a network, such as shown in FIG. 1, so that there will be one or more BS's in certain directions, in such a manner as to prevent interference to BC users. In particular, it is possible to place the BS's so that there will be no BC transmissions in that direction, or as little as possible. In this figure, the BS's are placed in such directions that if UT's will communicate with them, they will not interfere with BC listeners.

The mows above UT's 31, 32 and 41 indicate each a communication direction with BS. It may be possible to set up such a direction so that minimal interferences to BC users will occur, assuming the BC stations locations are known, or BC transmissions are identified.

BC users 51, 61 and 71 can receive BC transmissions of BC 5, 6 or 7. In this embodiment, it is desired that no UT or BS transmission will be in the direction of the BC transmissions, for the BC users. Thus, even if there is a UT behind some BC users, interferences can be prevented by selecting appropriate BS in other direction.

UT 31 can communicate with BS 3, UT 41 with BS 4 and UT 32 can communicate with BS 3.

If UT 32 is too close to user 61 and it is not desired that BS 3 would transmit in that direction because of the transmission of BC 3, then it may communicate with other BS's instead, such as BS 4 or BS 2.

It can be seen that, ideally, the directions of the BS's are different from the transmission of the BCs.

The sectors of the BS's may be adjusted for the BC's. UT's may communicate with more than one BS, wherein each is in a different direction.

In addition, microphones may start transmitting, such as 81, 82 and 83. In case a microphone transmits, it is possible not to use its resources in the relevant sector or area, so that BS's or users covering this area will not interfere with the microphone.

Thus, as BS 2 senses the presence of the microphone 82, or is being told about the presence of such a device by a UT, resources for UT's in that relevant direction will be changed. This may be by the control of the BS.

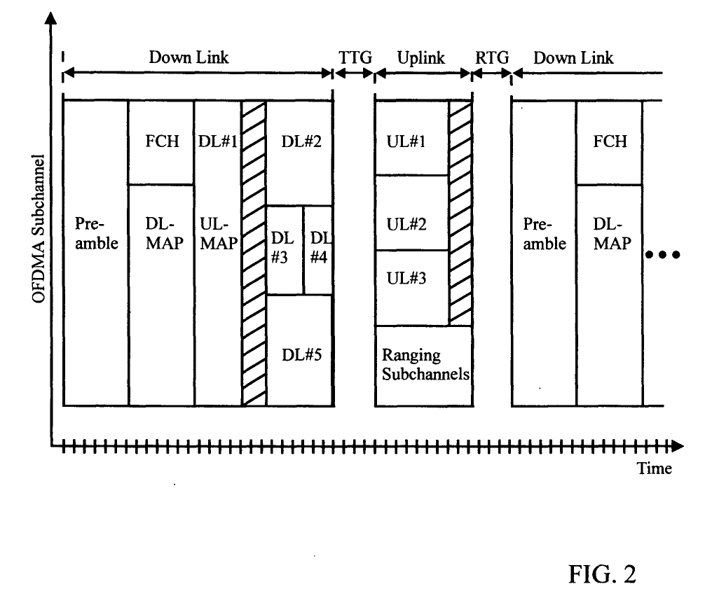

FIG. 2 details a transmit frame for OFDMA including Sensing windows set in the time/frequency domain.

The Y Axis indicates the frequency, or Sub-channels defined in the frequency domain and spaced as defined by the standard, such as 802.16.

The X Axis indicates the time, or fixed time intervals spaced as defined by the standard, such as 802.16.

This frame comprises some blank time spaces, TTG and RTG, Downlink DL and

Uplink UL intervals.

The DL is transmitted from the BS to the UT's, and may comprise known data types as shown in the figure.

The data being transmitted by the BS is described in the DL-MAP. The data, which will be transmitted by UT's is described in UL-MAP.

Using such a frame formation, it is possible to control what data will be transmitted, by whom and when. Thus, it is possible to efficiently adjust the usage of resources.

It may be possible to define sensing windows, such as by not transmitting any data there. The Oblique lines represent sensing windows set for acquiring other communications in the area. It is possible that the BS and/or the UT's will use these windows for tracing other kinds of data, such as microphones and BC's.

In a preferred embodiment, it may be possible to further analyze that data in order to learn about the nature of the transmission, such as its approximate location, type of data (BC, microphone, etc.) frequencies amplitudes at different areas, etc.

UT's may update the BS about data received in sensing windows. It is preferred that the BS will gather all the relevant windows information and decide what to do and how to manage the cellular network.

In some preferred embodiments, it may be possible to adapt an OFDMA network system for using sensing windows at UT's and/or BS's without adding additional hardware, such as by implementing these modes of operation at the MAC layer in BS's and UT's, so that data will be shared and the BS's will control the sensing windows.

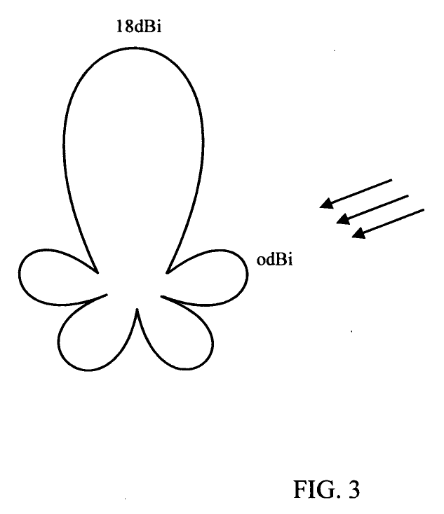

Altogether, this may allow accessing more resources while stopping communications in resources where it might interfere with other devices or BCs. FIG. 3 details the main lobe and side lobes of a user's terminal antenna for directional transmission towards a base station of the new system and for prevention or reduction of interferences.

The upper lobe represents the main lobe of a user. In another embodiment, the main lobe of a BC receiver will not point towards a BS. Thus, the BC user will be less exposed to BS transmissions.

The UT capable of transmitting towards a specific direction will be set to cause minimum interferences.

It may be possible to use at the BS PUSC Partial Usage of Sub-channels per sector and/or FUSC Full Usage of Sub-channels per sector for preventing interferences. Thus, in cases it is unpreventable to transmit to a main lobe of a BC user or when there is a Microphone in the sector, PUSC can be used rather than FUSC, ensuring sensitive frequencies are not in use.

It may be possible to characterize the main lobes of users, based on reception and amplitudes of transmissions at different locations. It is desired to point main lobes of UT's so that they will point to a BS in such a manner to cause minimal disturbances. For example, the gain at the main lobe (up most point in the chart in FIG. 3) may be about 18 dBi, wherein at the side lobes the gain may be about 0 dBi or less.

The arrows represent other transmissions, which is not of interest to the receiver. Thus, it is possible to attenuate unwanted signals from different directions, such as by using a directional antenna and/or using an array of two or more antennas.

It is preferred that BC users would use directional antenna means as well, since the direction of BC transmission may be fixed and known. This will allow them to attenuate BS's and UT's transmissions, which are in different directions.

In general, it is preferred that BS's and UT's will be set to manage a directional communication as much as possible.

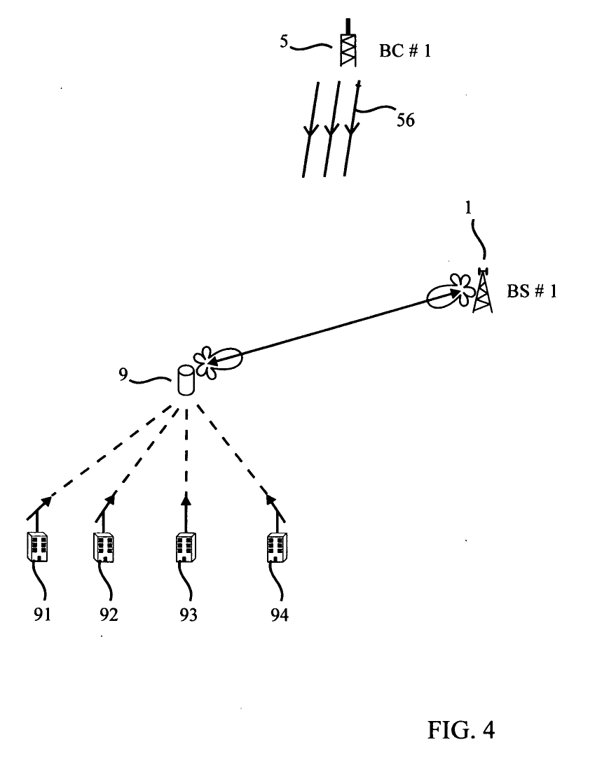

FIG. 4 illustrates a system with router means 9 for communicating between a residential community 91-94 and a base station 1 of the second system, wherein the second system base station is generally in the same direction as the first system base station 5.

It may be possible to use router and/or repeater and/or other means 9 which are compatible to communicate with the BS 1 or the cellular network and with UT's, such as 91-94, and wherein these means are placed closer to the UT's for providing a better communication quality. It is understood that whenever router or repeater are mentioned, such alternatives may be used as well.

Using the repeater 9 may simplify the hardware and software, as the repeater may not be required to process the information or make decisions, but simply to exchange data between the UT's and the BS.

Preferably, the repeater would include directional transceiver means for communicating with the BS directly and with minimal interference to the nearby area.

This may also allow connecting UT's to a distant BS more efficiently. A directional lobe, similar to that described with reference to FIG. 3, is shown near the BS and the Repeater, wherein the solid line between them indicates directional communication.

Each of the UT's may be set and/or tuned so that it is wirelessly connected to the router. It is preferred that the UT's would use directional communication with the router.

In a preferred embodiment, the UT's may connect to the BS automatically through the repeater, according to cellular standard, such as 802.16 using OFDMA, allowing them to decide when and in which method they wish to connect, such as for data transmission or voice conversation, etc.

When a BC transmitter 5 is present in a direction which is about the same as that of the BS 1, for some users, then it may be useful to use the repeater 9, so that the direction of BC transmission 56, will less interfere, and the UT's 91-94 will not have to communicate with a BS which is in about the same direction of the BC transmitter.

The BS 1 will be able to transmit in the exact direction of the repeater, which can be located to support communications in a different direction. This can improve both cellular and BC communication quality.

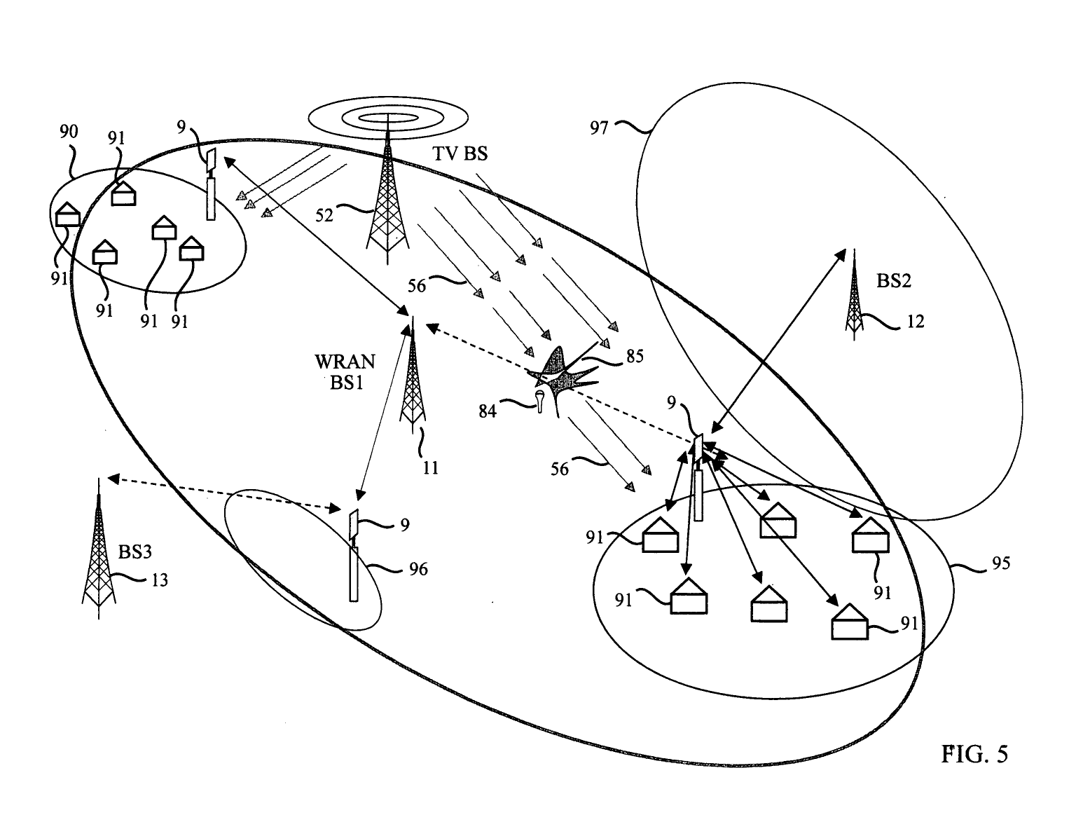

FIG. 5 illustrates a macro-diversity system with several repeaters 9 to be used with a cellular network in a residential community.

In this embodiment, an existing cellular network such as a network with WRAN BS1 11, over a certain area, may include new features.

One or more windows can be opened, to identify B.C. and Microphones. These windows can be similar to those described in FIG. 2.

It may be possible by scanning to find free channels and use them. Sensing can be implemented as well for finding other transmissions.

Whenever windows are mentioned, the same may apply to sensing and/or scanning, with the common purpose of finding other transmissions. Different techniques/methods and hardware devices may be used for this purpose. Data regarding other transmissions may be reported to BS's.

This may be implemented at the BS and/or UT's and/or Users, which should update the BS about other transmissions found and their characteristics. Using this technology, it is possible to use unlicensed bands and use the bandwidth better.

In this embodiment, WRAN BS 1 communicates with some residents in a certain area 95, then a TV BS 52 and/or a Microphone 84 may transmit. As this happens, a transmission 56 of the TV BS or of the Microphone 85 is received by the BS 11 and/or UT's 91 of the cellular network.

The Microphone or TV BS may be traced while sensing and/or while detecting low communication quality and/or by identifying distortions from which it is possible to find the nature of a transmission.

It is possible then, to deploy other BS, such as BS2 12, which is in another direction. It may also be possible to deploy a repeater 9 in area 95, for providing communication support to UT's 91 in the area 95.

The repeater 9 may be simple and yet provide efficient broadband directional communication with BS2 12, at lower interference levels, as shown by the line between the repeater 9 and BS2.

Although the area and/or sectors 97 of BS2 may be different and distant, BS2 can still support users in area 95. In particular, this may be useful if BS2 has more free resources than other BS's.

Similarly, BS3 13 may provide support to area 96 using a repeater 9 in this area. This may allow further reducing the number of UT's of BS1 and allowing BS1 to support other users.

For example, BS1 may give a better support to UT's 91 in area 90, again with a repeater 9 in that area. This may be useful such as in case the BC transmissions such as of the TV BS 52 are from different directions and there are less or no microphones between the repeater 9 and the BS1 11.

Using any of the embodiments presented in this paper, it is possible to have a Low Interference Configuration—thus microphones and BC's would work effectively in the presence of a cellular, Macro Diversity network, such as the one presented in FIG. 5.

A problematic path, such as between BS 1 and the repeater 9 in area 95, can be cancelled, allowing HO Hand-Off or similar methods, in which communication support would be provided from another BS or repeater. Repeaters may comprise an Array of several antennas, such as three separate antennas.

Using repeaters efficiently may reduce radiation, such as having an Area 95 covered with Low Power Transmission of Less than 1 Watt.

Using any of the embodiments presented in this paper, it is possible to sense licensed transmissions, such as with an omni-directional antenna.

Based on resources usage, it may be possible to analyze and calculate whether and how it is possible to transmit in the presence of the B.C. and the Microphones.

Operating an adaptive network with one or more Base Station B.S., preferably having directional sectors. Thus, it is possible to set transmissions and their directions so that they will not interfere with a B.C. A User Terminals UT of the adaptive network may perform directional communications as well—for reducing possible interference to the B.C. and microphones. The B.S. manages the communications and determines the communications strategy adaptively.

It may be possible to switch between BS's in the network, this may allow to avoid or reduce interferences to microphones or using other options, such as switching to other frequencies.

It may be possible to look through using one or more windows in the Uplink UL and/or in the Downlink DL. These windows may allow identifying B.C. sources and Microphones. It is possible to identify these transmissions such as by testing pilot signals as well. In some embodiments, the bandwidth and/or center frequency of B.C.'s and/or microphones has a finite number of possibilities. For example, the bandwidth of microphone transmission may be about 200 KHz.

Furthermore, it is possible to build an updateable database, which holds the data of other transmissions, and their characteristics. For example a center frequency and bandwidth of each transmission sensed.

Optionally the location, power and the schedules of transmissions may be saved in the database as well.

The database would preferably be kept in the BS, wherein data may be synchronized between different BS's or taken from other sources.

In some embodiments, an omni-directional antenna can be used for sensing. This method is simple and provides information about other transmissions in any direction.

It is possible to synchronize between BS's of the adaptive network, to allocate resources and users and to receive data regarding B.C.'s and Microphones in relevant areas. UT's may open windows as well. They may then update the adaptive network about B.C.'s and Microphones in relevant areas. This is especially useful in order to reveal transmissions near the UT.

The adaptive network may include one or more wireless routers/relay means for improving wireless access to several UT's in a problematic area. This may include areas where there are B.C.'s from many directions and/or for areas it is not practical to access using a specific B.S.

The router may efficiently communicate with the UT's forming a focused array, and can be placed closer to them than a B.S. The router would communicate with the B.S. more efficiently, such as by using directive communication means. Yet the router can be cheaper and simpler than the B.S. since it mainly routes the data, avoiding complex operations.

In another embodiment, it is possible to define a method for placing BS's network. The placement of the BS's would be made according to the location and positioning of B.C. transmission means.

It will be recognized that the foregoing is but one example of a system and method within the scope of the present invention, and that various modifications will occur to those skilled in the art upon reading the disclosure set forth hereinbefore.

1. A cellular network including means for sensing the presence of Microphones and Broadcastings and for adjusting resources usage for not interfering the transmissions of the Microphones and Broadcastings.

2. A cellular network including means for sensing the presence of Microphones and Broadcastings and for adjusting resources usage for not interfering with the transmissions of the Microphones and Broadcastings over a certain level.

3. The cellular network according to claim 2, wherein the Microphones and Broadcastings are traced by one or more BS's and UT's.
